(19) United States
(12) Patent Application Publication
(10) Pub. No.: US 2007/0287475 A1
(43) Pub. Date: Dec. 13, 2007

(54) Automatic Position Registering Method in a Mobile Phone

(76) Inventors: Kee-Joong Jeong, Seoul (KR); Dong-Won Na, Yongin-si (KR); Won-Hee Sull, Seongnam-si (KR); Bong-su Um, Seongnam-si (KR); Jun-Woo Lee, Seoul (KR)

Correspondence Address: ANDERSON, KILL & OLICK, P.C., 1251 AVENUE OF THE AMERICAS, NEW YORK,, NY, 10020-1182, US

(21) Appl. No.: 11/572,355

(22) PCT Filed: Oct. 1, 2004
(86) PCT No.: PCT/KR04/02514

§ 371 Date: Feb. 1, 2007

(30) Foreign Application Priority Data
Jul. 20, 2004 (KR) 10-2004-0056471

(51) Int. Cl. H04Q 7/20

(52) U.S. Cl. 455/456.6; 455/456.1

(57) ABSTRACT

Disclosed is an automatic position registering method in a mobile phone for minimizing a load of a server related to a position information by enabling the position information to be transmitted to LBS (Location Based Service) server if a predetermined given condition is satisfied after the position information of mobile phone is obtained by an operation of a predetermined program for obtaining the position information of mobile phone. The method comprises the steps of: requesting a driving of a position information managing application built in a mobile phone by LBS server and connecting the position information managing application and LBS server; transmitting a condition for managing the position information to the mobile phone from LBS server; and checking whether the position information managing application is capable of obtaining and uploading the position information based on the condition and then transmitting the position information to LBS server.

### FIELD OF THE INVENTION

The present invention relates to a location based service, and more particularly to an automatic position registering method in a mobile phone for minimizing a load of a server related to position information by enabling the position information to be transmitted to LBS (Location Based Service) server if a given conditions are satisfied after obtaining the position information by automatically operating a program in a mobile phone in order to obtain the position information of the mobile phone for the location based service.

### BACKGROUND OF THE INVENTION

For the conventional LBS (Location Based Service), generally the system of searching location of a certain mobile terminal by the LBS server acquiring location information from the mobile phone by the order of the LBS server has been used prevalently. In this event, whenever the location information is needed, a request message is transmitted from the LBS (Location Based Service) server to a certain mobile phone, and the location information is transmitted from the mobile phone to the LBS (Location Based Service) server. Thus, whenever a location request message is transmitted, a certain amount of network resource is needed. Hereinafter, the position registering method of a mobile phone according to the conventional technology will be explained by referring to FIGS. 1 and 2.

FIG. 1 is a diagram showing the position registering system of a mobile phone according to the conventional art. FIG. 2 is a call flow chart for explaining the registering method of a mobile phone according to the conventional art.

As shown in the figures, reference number 10 represents a mobile phone; reference number 300 represents a location information providing system; and reference number 400 represents an LBS server. In the position registering system (100), reference number 110 represents a base transceiver station (BTS); reference number 120 represents a base station controller (BSC); reference number 130 represents a mobile switching center (MSC); reference number 140 represents an interworking facility (IWF); reference number 150 represents a signal transfer point (STP); and reference number 160 represents a home location register (HLR) Also, in the location information providing system (300), reference number 310 represents a position determination entity (PDE), and reference number 320 represents a mobile positioning center (MPC).

The position registering system (100) is coupled to the position determination entity (310) of the location information providing system (300) and to the mobile positioning center (320) through the signal transfer point (150).

The LBS server (400) provides location information service according to the request of a mobile phone user. Preferably, it is coupled to the mobile positioning center (320) of the location information providing system (300) by TCP/IP.

The operating process of the position registering system of a mobile phone according to the conventional art, which has been constituted as described above, will be explained by referring to FIG. 2.

First, the LBS server (400) requests the mobile positioning center (320) to provide a location service (S110). Then, the mobile positioning center (320) sends an SMSREQ request message to the home location register (160) based on the MIN (Mobile Identification Number) of the mobile terminal which requested to provide a service (S120). Herein, SMSNOTIND among the parameters of the SMSREQ messages is sent to 2, thereby preventing SMS pending.

Thereafter, the home location register (160) sends an SMSREQ return result message to the mobile positioning center (320) (S130). Then, the mobile positioning center (320) analyses SMSADDR comprised in the received SMSREQ return result message, and checks whether or not the incoming switching system enables the GPS based location service function. Herein, the mobile positioning center (320) sends GPOSREQ request message to the position determination entity (310) based on the result of the judgment of the incoming switching system concerning whether or not to provide the GPS based location service (S140). The parameters, which are sent together with the GPOSREQ message, comprise MOBINFO, POSREQTYPE and MPCAP.

Subsequently, the position determination entity (310) acquires the location information of a mobile terminal for which the location based service has been requested based on the IS-801-1 standard (S150˜S230) The location information received by the position determination entity (310) is sent to the mobile positioning center (320) through the GPOSREQ message. The parameters of the GPOSREQ message comprise POSINFO and POSRESULT.

Then, the mobile positioning center (320) sends the location result to the LBS server (400) (S250). Meanwhile, after the position determination entity (310) ends a message to the mobile positioning center (320) Lke the above, it sends an SMDPP message to the mobile qitching center (MSC) in order to release resources seated therein (S260˜S290).

The mobile positioning center (320) functions as a gateteway between the mobile communication switching network and the LBS server (400). According to the location information request of the LBS server (400), it requests the mobile phone (10) to provide location information, and then if a location value is received from the mobile phone (10), it converts the value to real place name information and sends it to the LBS server (400). If the location information is sent to LBS server (400) through the mobile positioning center (320), the LBS server (400) helps it to be utilized in supplying various location based services.

The above example concerns a GPS based location checking method. However, in the conventional location based service, whenever there is a necessity, the LBS server (the server handling location management) \textcircled{1} requests a terminal to register location, demands the terminal to calculate the location information, and receives a location value therefrom, or \textcircled{2} receives the location of the terminal measured by a base transceiver station (or a system which functions similarly thereto and a system apparatus handling mobile communication) or by a server system by using the location checking method based on the base transceiver station, the above GPS based location check, or ETDOA location checking system.

Thus, for the above methods, the location checking request must be made from the LBS server to a terminal for all the location based services. For the purpose, communication between another apparatus of a mobile communication network (e.g., a system for checking location by a base transceiver station, GPS or ETDOA, etc.) and a terminal and continuous upload of location data are required.

At this time, according to the request of the LBS server every time, the location is checked by the communication between the location checking system (e.g., HLR/MSC, MPC/PDE or a similar apparatus handling location measurement and the like) and a terminal. The terminal sends the measured value to the LBS server directly or through the location checking system.

For the location check, every time, a number of apparatuses are required for the connection and communication with a terminal. Thereby, when there are a lot of requests for location check, considerable load is caused for both the terminal and the location checking system. Thus, expensive location system apparatus needs to be further established. Also, as well as the mobile communication network, it may effect associated services.

Currently, in the domestic location checking system, the location check is divided into Cell-ID based location check and AGPS based location check and requests an assigned server to provide services by using the location check result. This method has a problem that when Cell-ID request is made from the LBS server to nearly all of the location based services, in case of HLR (including the apparatus playing a similar role as the home location register in GSM and WCDMA) and AGPS, the location information is requested to PDE, therefore the load of wireless network requiring location registration and LBS server including CDMA network (including MSC, BSC, BTS as well as HLR, PDE), GSM network or WCDMA network gets increased (When GSM, WCDMA system or another location checking method, e.g., ETDOA and the like, is used, the fundamental function is similar in proceeding with the location check in spite of slight differences in the system terms).

Particularly, in case of a Cell-ID based system, it employs the page request method. If there are excessive page requests, it may influence on a voice telephone call by network occupation.

Meanwhile, in case of AGPS, location is measured by using IS-801-1 protocol between PDE and a terminal. However, when the requests increase, expensive PDE devices are required to be additionally established, which increases the development costs and hinders service development. Further, when periodic location confirmation requests are required, overload may occur in HLR, MSC (Cell-ID based system), PDE and MPC (AGPS based system). Accordingly, there was a problem that the number of users is limited.

### SUMMARY OF THE INVENTION

Therefore, the present invention has been conceived in order to resolve the aforesaid problems in the prior art. The object of the present invention is to provide an automatic position registering method of a mobile phone which can minimize the load of the LBS server and the location acquisition cost, by presenting a location acquisition system based on the mobile phone replacing the location acquisition system based on the LBS server, and by enabling to check the location of a mobile telecommunication at a certain area.

In addition, another object of the present invention is to provide an automatic position registering method, characterized by transmitting the location information, which is obtained from a mobile phone, directly to the LBS server without requesting real time location information from the LBS server to the mobile phone.

In order to achieve the above object, the automatic position registering method of a mobile phone according to the present invention comprises: A) an LBS (Location Based Service) server requests a location information managing application (not shown) installed in a mobile phone to operate; B) said location information managing application operates according to said request, and said location information managing application is connected with said LBS server; C) the location information management conditions are transmitted from said LBS server to said mobile phone; and D) after said location information managing application, which has received said conditions, checks whether or not to acquire and upload location information according to said conditions, the location information is transmitted to said LBS server.

### BRIEF DESCRIPTION OF THE DRAWINGS.

FIG. 1 is a diagram showing the position registering system according to the prior art.

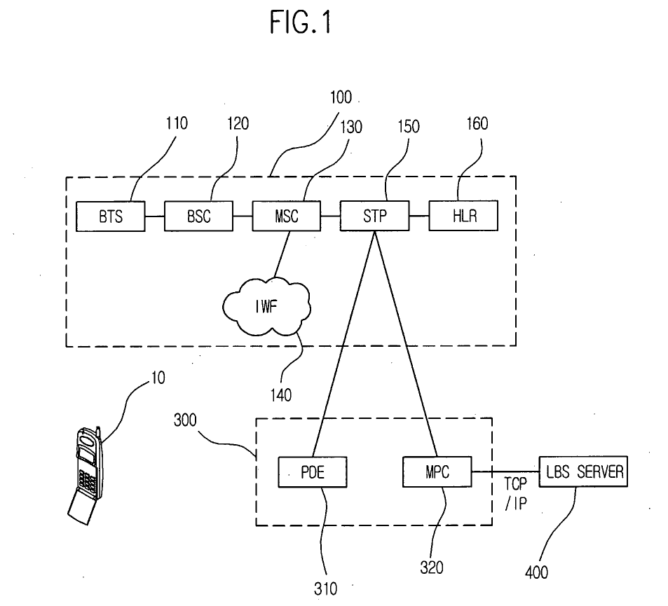

FIG. 2 is a call flow chart showing the position registering method according to the prior art.

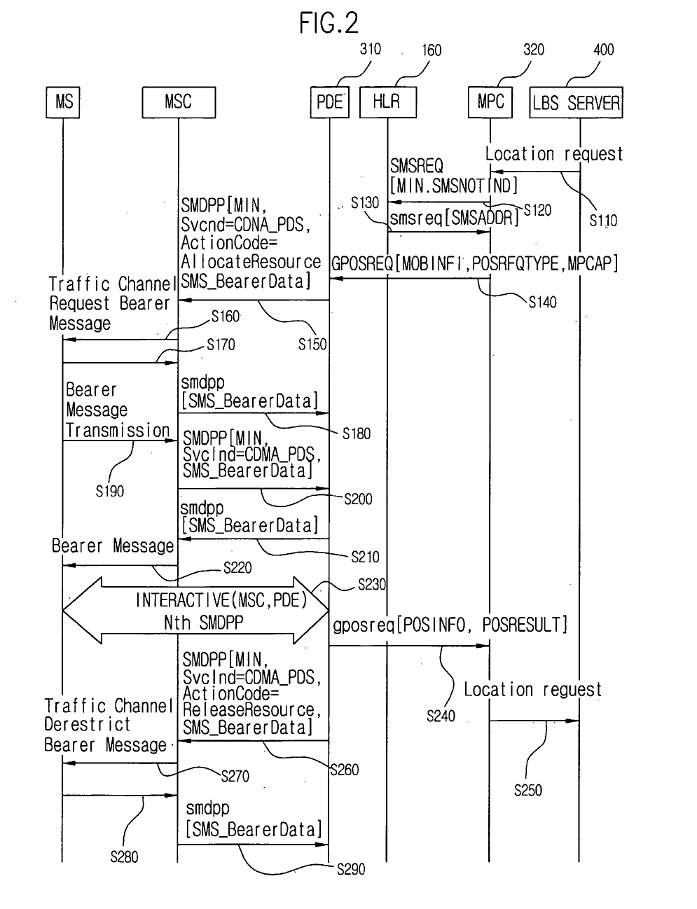

FIG. 3 is a flow chart for explaining the automatic position registering method according to the present invention.

### DETAILED DESCRIPTION OF THE PREFERRED EMBODIMENT

Hereinafter, the preferred embodiments of the present invention will be further explained by referring to the drawings attached hereto.

As illustrated in the drawings, the automatic position registering method of a mobile phone comprises that an LBS (Location Based Service) server (20) requests a location information managing application (not shown) installed in a mobile phone (10) to operate (S10); said location information managing application operates according to said request, and said location information managing application is connected with said LBS server (20) (S20); the location information management conditions are transmitted from said LBS server (20) to said mobile phone (10) (S30); said location information managing application, which has received said conditions, checks whether or not to acquire and upload location information according to said conditions (S40); and the location information is transmitted to said LBS server (20) (S50).

The wireless Internet protocol can be applied to the mobile phone (10). Also, through the transmission network, which can provide IP protocol according to WAP service, Call Back URL and WAP push, and the IP Backbone network, the mobile phone (10) can communicate with the LBS (Location Based Service) server (20).

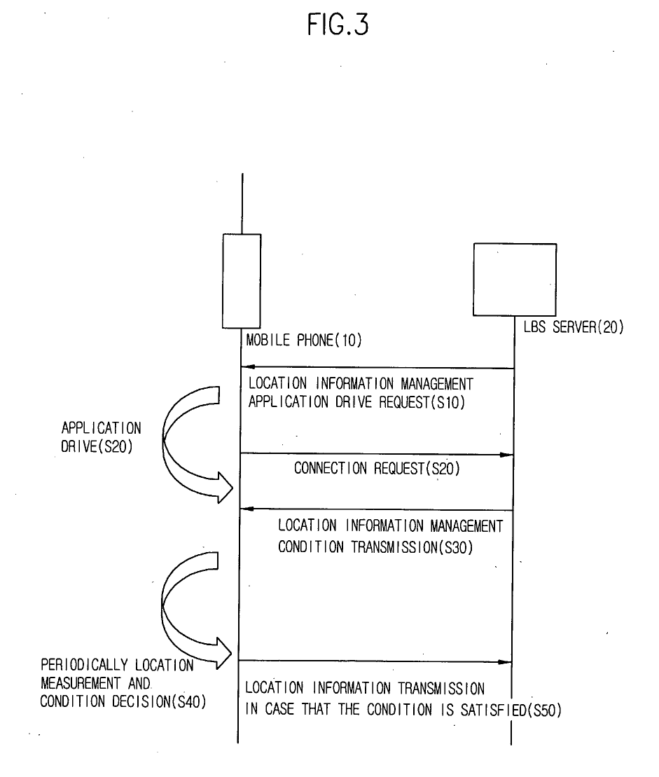

The automatic position registering method configured as the above according to the present invention will be explained by referring to FIG. 3 in the below.

FIG. 3 is a diagram for explaining the automatic position registering method according to the present invention.

First, if the LBS server (20) request the location information application (not shown) installed in the mobile phone (10) (S10) to operate, the mobile phone (10) operates the location information managing application. Hence, the location information managing application is connected to the LBS server (20) (S20). At this time, the LBS server (20) transmits the location information acquisition and transmission conditions to the mobile phone (10) (S30). In other words, the LBS server (20) does not request the mobile phone (10) to provide real time location information, but simply transmits the conditions.

The location information acquisition and transmission conditions between the LBS server (20) and the mobile phone (10) are transmitted by using SMS, or are transmitted from the LBS server (20) to the mobile phone (10) after TCP/IP connection, HTTP connection or SOAP connection from the mobile phone (10) to the LBS server (20).

The location information acquisition and transmission conditions are divided into time conditions (which means transmission of location information within a given time) and geographical conditions. The time conditions includes location information acquisition and transmission start time, their periods and their termination time. Meanwhile, the geographical conditions includes a management area of a certain switching system, a management area of a certain plurality of base transceiver station groups, a management area of a certain base transceiver station, a center, coordinates and a radius of a certain base station or a certain address information.

In addition, the geographical conditions may be administrative appellations such as “Gu (e.g., Gangnam-Gu, Jongno-Gu, etc.)” or “Dong (e.g., Seorin-Dong, Pil-Dong, etc.)” among certain address information. Also, it may be an administrative district code and an administrative radius of certain address information.

The location information acquisition and transmission conditions are transmitted to the LBS server (20) after the location information managing application built in the mobile phone (10) calculates location information on the basis of the conditions.

Thereafter, the location information managing application, which has received the above conditions, determines whether or not to acquire and upload location information according to the above conditions (S40). Herein, while the location information managing application of the mobile phone (10) is measuring the location of the terminal periodically irrelevant to the location information management conditions of the LBS server (20), it checks whether or not to acquire and upload the location information according to the above conditions in case that it receives the location information management conditions from the LBS server (20).

As stated above, the location information acquisition of the location information managing application can be performed independently rather than through communication with a certain server for location measurement, but the location may be still acquired through the communication with a given location measurement server after being performed at a terminal.

In addition, the accuracy of the location information acquired by the location information managing application is evaluated based on an area managed by a certain switching system, an area managed by a single base station, a group of areas managed by a plurality of base stations, and coordinates which are obtained from the GPS receiver installed in the mobile phone (10). Additionally, the accuracy of the location information acquired by the location information managing application can be computed based on the area or the spot measured and acquired by the mobile phone (10).

Thereafter, the location information managing application of the mobile phone (10) transmits location information, which is periodically measured, to the LBS server (20) only when it meets the location information management conditions (S50). Herein, the location information managing application works in the background state, i.e., when the terminal screen is inactive or when the user does not recognize.

However, the location information may not be transmitted to the LBS server (20). Instead, it can be simply used in the location information managing application of the mobile phone (10).

The location information managing application stores the above acquired location information in a given database. It compares the location information in the past certain spot with the current location information, and transmits the location gap to the LBS server (20).

Finally, the above location acquisition and transmission process are stopped by the stop or termination order of the LBS server (20).

The location measurement and the location transmission between the mobile phone (10) and the LBS server (20) are performed by the connection with TCP/IP Protocol, HTTP Protocol or SOAP Protocol.

The accuracy of the location information may be a management area of the switching system according to a service request, or it may be utilized as one area by combining several base stations together. Also, if the location information is used based on a base station, it may be ETDOA, TDOA, GPS (including AGPS) system, which are more accurate.

Thus, as explained above, the conventional method performs the location information management in the LBS server and the communication between the LBS server and the terminal for location measurement every time, whereas the present invention minimizes the communications for the location measurement and management between a mobile phone and the LBS server, makes the location information acquisition and transmission management to be performed in a terminal, and transmits the location information to the LBS server only when it is necessary (i.e., if the conditions required by the LBS server is satisfied), thereby the location information can be timely acquired.

As described above, the automatic location registration method of a mobile phone according to the present invention can be used not only for the hand-set based Cell-ID method and network based GPS method which are presently used domestically, but also for other methods for location measurement. Hence, the present invention is capable of reducing overload of position measurement server (PDE), switching system (MSC), base station system (BSC, BTS) and LBS server, while increasing their efficiency. Particularly, it is possible for the terminal by itself to calculate and decide location information, so that the overload applied to the HLR can be considerably reduced, and the overload applied to the PDE can be almost eliminated except for the overload consumed in TTFF (Time To First Fix).

According to the request of a user, one or two operation(s) can be carried out individually. A simple key operation of a user enables the individual operation.

Hence, according to the present invention, the overload of the system equipment can be minimized by the location information collection from the terminal. Accordingly, the service fee can be reduced, thereby it is expected that many position-based services, which were restricted by the expensive cost, can become available at a reasonable cost.

Also, in the present invention, the application of a terminal is performed in the background state, and then periodically acquires and compares the position information to transmit the location information to the LBS server only if it satisfies conditions, so that the communications between the position acquisition server and the terminal can be minimized. Also, if a certain position is obtained, the position is registered at the LBS server as real time data, thereby the present invention can be applied to the zone based separation/arrival related services usefully.

Although only one embodiment of the present invention has been disclosed for illustrative purposes, those skilled in the art will appreciate that various modifications, additions and substitutions are possible, without departing from the scope and spirit of the invention as disclosed in the accompanying claims.

What is claimed is:

1. An automatic position registering method of a mobile phone comprises the steps of:
A) driving the location information managing application of a mobile phone according to the request of an LBS server and connecting said location information managing application with said LBS server;
B) transmitting location information management conditions from said LBS server to said mobile phone; and
C) transmitting said location information to said LBS server after checking the location information acquisition and the upload according to said conditions by said location information managing application which has received said conditions.

2. The automatic position registering method of a mobile phone according to claim 1, characterized in that said mobile phone transmits the location information, which was acquired by itself, to said LBS server.

3. The automatic position registering method of a mobile phone according to claim 1, characterized in that said mobile phone transmits the location information, which was acquired by itself, to said LBS server according to a real time location information requesting message from said LBS server.

4. The automatic position registering method of a mobile phone according to any one of claims 1 to 3, characterized in that said mobile phone periodically transmits the location information, which was acquired by itself, to said LBS server.

5. The automatic position registering method of a mobile phone according to any one of claims 1 to 4, characterized in that said location information is acquired directly by said mobile phone without communicating with a certain server for location measurement.

6. The automatic position registering method of a mobile phone according to any one of claims 1 to 4, characterized in that said location information is acquired by said mobile phone through communication with a certain server for location measurement.

7. The automatic position registering method of a mobile phone according to any one of claims 1 to 4, characterized in that said LBS server transmits the location information management conditions to said mobile phone, and receives the location information according to said conditions.

8. The automatic position registering method of a mobile phone according to claim 1, characterized in that said location information management conditions are received by said location information managing application of said mobile phone, then accordingly said location information managing application acquires the location information, and the location information, which acquired by the mobile phone, is transmitted to said LBS server.

9. The automatic position registering method of a mobile phone according to claim 7 or 8, characterized in that said location information management conditions are location information acquisition and transmission conditions, which comprise time conditions or geographical conditions.

10. The automatic position registering method of a mobile phone according to claim 9, characterized in that said time conditions comprises the location information acquisition, the transmission start time, the period and the termination time.

11. The automatic position registering method of a mobile phone according to claim 9, characterized in that said geographical conditions comprises a management area of a certain switching system, a management area of a certain group consisting of a plurality number of base stations, a base station management area of a certain base station, a center coordinates and radius of a certain base station, certain coordinates and radius and/or certain address information.

12. The automatic location registration method of a mobile phone according to claim 9, characterized in that said geographical conditions comprise minimum basic unit of an administrative area in certain address information or a district number and diameter of the administrative area of the certain address information.

13. The automatic position registering method of a mobile phone according to claim 1, characterized in that the accuracy of said location information is computed based on the area managed by a certain switching system.

14. The automatic position registering method of a mobile phone according to claim 1, characterized in that the accuracy of said location information is computed based on the area having a group consisting of a plurality of base stations.

15. The automatic position registering method of a mobile phone according to claim 1, characterized in that the accuracy of said location information is computed based on the area managed by a single base station.

16. The automatic position registering method of a mobile phone according to claim 1, characterized in that said location information is computed based on the coordinates which are obtained by using GPS installed in the mobile phone.

17. The automatic position registering method of a mobile phone according to claim 1, characterized in that said location information is obtained by the location measurement being conducted in the mobile phone on behalf of a certain base station and a certain switching system.

18. The automatic position registering method of a mobile phone according to claim 1, characterized in that said location information acquisition and transmission are stopped by the stop or termination order of said LBS server.

19. The automatic position registering method of a mobile phone according to claim 1, characterized in that said location information managing application compares the location information at a certain past spot with that at a certain present spot, and transmits the location gap to said LBS server.

20. The automatic position registering method of a mobile phone according to claim 1, characterized in that the location measurement and transmission at said step (C) from said location information managing application to said LBS server are conducted by using SMS and the connection with TCP/IP Protocol, HTTP Protocol or SOAP Protocol.

21. The automatic position registering method of a mobile phone according to claim 1, characterized in that the location information management conditions from said LBS server to said mobile phone at said step (B) are transmitted from said LBS server to said mobile phone by using SMS, or after TCP/IP, HTTP or SOAP connection from said mobile phone to said LBS server.

22. An automatic position registering method of a mobile phone comprises the steps of:
A) driving a location information managing application of a mobile phone and connecting said location information managing application with an LBS server;
B) transmitting location information management conditions from said LBS server to said mobile phone;
C) checking whether or not to acquire and upload location information according to said conditions by said location information managing application which has received said conditions; and
D) transmitting the location information to said LBS server if the result of said step (C) satisfies said conditions.

23. The automatic position registering method of a mobile phone according to claim 22, characterized in that said mobile phone transmits the location information, which has been acquired by itself, to said LBS server without receiving any real time location information requesting message from said LBS server.

24. The automatic position registering method of a mobile phone according to claim 22 or 23, characterized in that said mobile phone periodically transmits the location information, which has been acquired by itself, to said LBS server.

25. The automatic position registering method of a mobile phone according to claim 22 or 23, characterized in that said location information is acquired directly by said mobile phone without communicating with a certain server for location measurement.

26. The automatic position registering method of a mobile phone according to claim 22, characterized in that the accuracy of said location information is computed based on coordinates which are obtained by using GPS installed in an area managed by a certain switching system, an area of a group consisting of a plurality of base stations, an area managed by a singular number of base station or the mobile phone.

27. The automatic position registering method of the mobile phone according to claim 22, characterized in that said location information management conditions are location information acquisition and transmission conditions, which comprise time conditions or geographical conditions.

28. The automatic position registering method of a mobile phone according to claim 27, characterized in that said time conditions comprise the location information acquisition, the transmission start time, the period and the termination time; and said geographical conditions comprise minimum basic unit of an administrative area in certain address information or a district number and diameter of an administrative area of a certain address information.

29. An automatic location registration method of a mobile phone, characterized by comprising the steps that:
A) an LBS (Location Based Service) server requests actuation of a location information managing application built, in a mobile phone;
B) said location information managing application is driven according to said request, and said location information managing application is connected with said LBS server;
C) location information management conditions are transmitted from said LBS server to said mobile phone;
D) said location information managing application, which has received said conditions, decides whether or not to acquire and upload location information according to said conditions; and
E) said location information is transmitted to said LBS server if the result of said step (C) satisfies said conditions.

30. The automatic position registering method of a mobile phone according to claim 29, characterized in that the location information transmission from said location information managing application to said LBS server at step (E) is conducted by connection with TCP/IP Protocol, HTTP Protocol or SOAP Protocol.

31. The automatic location registration method of the mobile phone according to claim 29, characterized in that the location information management conditions from said LBS server to said mobile phone at said step (C) are transmitted from said LBS server to said mobile phone by using SMS, or after TCP/IP connection from said mobile phone to said LBS server.
